(19) United States
(12) Patent Application Publication
(10) Pub. No.: US 2005/0049886 A1
(43) Pub. Date: Mar. 3, 2005

(54) System and method for managing digital rights and content assets

(75) Inventors: Michael Grannan, Austin, TX (US); Dinesh F. Nadarajah, Austin, TX (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, L.P.

(21) Appl. No.: 10/651,076

(22) Filed: Aug. 28, 2003

(51) Int. Cl. G06F 17/60

(52) U.S. Cl. 705/1

(57) ABSTRACT

A content broker hosting service is disclosed that includes a broker module configured to facilitate the management of digital content of an Internet user. The content broker hosting service supports a single sign-on user account that permits a subscriber to login to the content broker hosting service and other third party content providers that permit the sign-on credentials to be “federated” and used on their respective sites. Users may purchase content on the content hosting service site or from third party providers. The content hosting service maintains a directory of the devices a subscriber owns and of the content purchased. The rights usage policies and associated license keys are maintained on the hosting service to provide a digital “proof of purchase” for the content. In the event the content is lost by the subscriber, or if the subscriber chooses to change digital rights policies associated with the content, the broker hosting service may communicate with third party providers and negotiate for replacement content on the user's behalf.

### FIELD OF THE DISCLOSURE

The present application relates generally to a system and method for managing digital rights and content assets.

### BACKGROUND

The number of sites on the Internet selling digital content is continuing to increase. The advent of file sharing created interest in digital music, and major record labels are attempting to set up commercial web sites to let consumers purchase digital music legitimately. Similarly, the movie studios are cautiously approaching delivering first release movies over the Internet as digital rights management systems improve. At the same time, consumers are using various devices to access the Internet. In addition to the personal computer, there are now personal video recording devices, set top boxes, hi-fi stereo systems, personal digital assistants, and cellular telephones that can access and play Internet content. It will soon become more difficult for a consumer to manage digital content assets as the diversity of sites and devices expands.

The consumer might lose the device for which a particular content file was intended and/or stored on, or may wish to play the same content purchased on a different device for which the media format of the content is incompatible. Accordingly, there is a need for a system and method to manage the digital content a consumer has purchased or acquired.

### BRIEF DESCRIPTION OF THE DRAWINGS

FIG. 1 depicts an exemplary embodiment of a content broker hosting service and related systems.

FIG. 2 depicts an exemplary embodiment of a device profile table, and a media asset listing table to support managing the content a consumer has purchased.

FIG. 3 depicts exemplary methods and operation of the systems of FIG. 1 for the content broker hosting service to aggregate content titles from third party providers and facilitate the purchase of said content.

FIG. 4 depicts exemplary methods and operation of the systems of FIG. 1 for the content broker hosting service to respond to third party content providers when subscribers visit their web sites and request to purchase digital content.

FIG. 5 depicts exemplary methods and operation of the systems of FIG. 1 for the content broker hosting service to negotiate with third party providers.

### DETAILED DESCRIPTION

As consumers become more accustomed to obtaining movies, music, and software legitimately over the Internet, the ability to manage the licenses for, and storage of, their content will be desired. The ability for service providers to offer a hosted service that manages the purchase history and content storage for media purchased over a consumer's lifetime will benefit from a process for negotiating with the content owners for many purposes, including re-obtaining content that has been lost, changing the usage rights for the content, or obtaining a new data format for the content so it may be played on a device that was not originally intended when the content was purchased.

In a particular embodiment, a system is disclosed that includes a managed content broker service comprised of a single sign-on identity server, a broker module for obtaining or brokering content from third party sources, a storage area network for archiving digital content, and tables keeping track of the attributes of various devices and the digital content assets that a user owns. The content broker service includes a web server providing an Internet portal with which the user can browse various offerings of digital content available from other third party providers. These content offerings may be obtained from third-party content providers via web services technology, in which a third-party service advertises the content that is available and the rights policies that can be purchased. An Internet portal aggregates content from multiple third party providers and makes such content available to the consumer. When the consumer decides to purchase content, the Internet portal communicates to the third party provider, via a web services framework, to obtain approval to issue the content along with a license key appropriate for the usage rights purchased by the consumer. The content broker maintains a history of the purchase, including a unique purchase ID and the original license key issued by the third party provider, so that if the content is lost or must be re-appropriated (e.g. to work on a new or different device) the content broker may negotiate with the third party provider to update the digital rights policies and obtain a new copy of the content if necessary.

In another particular embodiment, the consumer may browse the web sites of independent third party content providers directly. When the consumer decides to purchase content, the content provider ascertains the consumer's identity by “federating” a single sign-on account that the user has established. This single sign-on account permits the user to move amongst various, unrelated sites and use the same account name and password (or other security tokens) for authentication. The content broker process is housed with a single sign-on identity server and can provide additional credentials as requested by the third party content provider when a purchase request is invoked. The information shared includes definitions of how the content will be managed (e.g., whether content is to be downloaded directly to the device of the consumer or stored in a personal storage area network managed by the content broker hosting service). The information shared may also include specific functional details and features of the device the user will consume the content on (e.g. memory availability, screen resolution, media formats playable, etc.).

In another embodiment, a system to provide a content brokerage service is disclosed. The system includes an interface to a distributed computer network. The distributed computer network provides access to a remote content provider. The system also includes a content broker module coupled to the interface and a single sign-on identity service to authenticate a subscriber to a content brokerage service supported by the content broker module. The system further includes a memory including content asset information and device profile information associated with at least one subscriber to the content brokerage service.

In another embodiment a method of managing content is disclosed. The method includes receiving a request for modified content with respect to a first version of content distributed to a user, determining a content provider associated with the first version of content, communicating data associated with the distribution of the first version of content to the content provider, communicating a modified content request to the content provider and receiving a second version of the content and a second license key associated with use of the second version of the content.

In another embodiment, a method of managing media content is presented. The method includes authenticating a subscriber to a content brokering site of a computer network, providing device characteristics of a subscriber media device, receiving content site header data relating to media type from the remote content provider site and receiving media content and an associated license key allowing access to the media content from the remote content provider site. The device characteristics are communicated from the content brokering site to a remote content provider site.

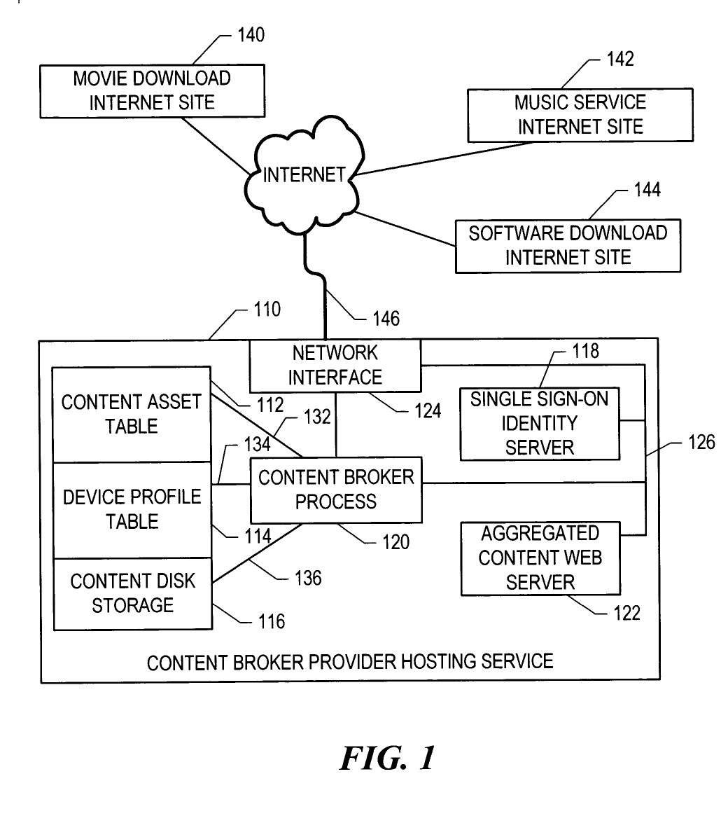

FIG. 1 depicts an exemplary embodiment of a system including a single sign-on identity server 118, a content broker process 120, an optional web server 122, a network interface 124, content asset 112 and device profile 114 database tables, and disk and/or database storage 116 for raw content. The entire configuration is referred to as a hosted content broker service 110. The major computing components of the architecture are connected to the Internet via the network interface 124. The single sign-on server 118, content broker process server 120, and aggregated content web server 122 are all physically connected through a data communications line 126. The data communications line 126 may be Ethernet cabling, power line networking components, or wireless (e.g. 802.11). The content broker process 120 has access to a database or other storage technique so that a content asset table 112 can be maintained which keeps a log of media content the user has purchased to date. In addition, a device profile table 114 maintains a list of the devices a consumer owns that can access the Internet or internal physical network for the purposes of retrieving and playing the media content. The device profile table 114 stores details on consumer devices including residential gateways, home servers, cable and satellite set top boxes, Internet ready DVD and hi-fi stereo components, MP3 players, etc.

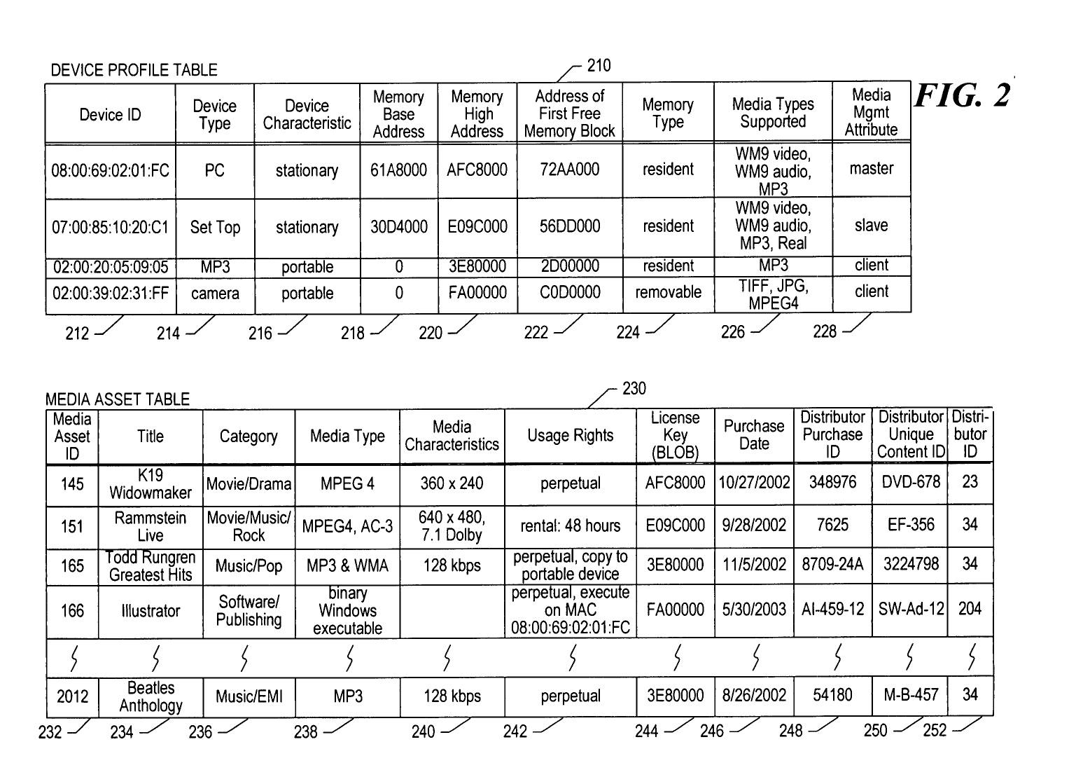

FIG. 2 depicts an exemplary embodiment of two table structures maintained and stored by the content broker process 120 on the content broker hosting service 110. The device profile table 210 maintains a list of the devices registered to ascertain its physical characteristics and capabilities to play distinct types of content. The media asset table 230 maintains the list of content that has been purchased by the consumer and is managed and stored by the content broker hosting service 110.

In the device profile table 210, each device is associated with a unique device identifier 212, which may be the MAC address of the device or some other identifying characteristic such as a serial number. The device type 214 is a general description classifier for the device, to assist in ascertaining usage and media format playback capabilities. A device characteristic 216 defines whether the device is stationary or portable. A memory base address 218 and memory high address 220 define the available memory range and addresses to assist the content broker 120 in determining the feasibility of delivering specific content files to the device. The base address 222 of the first free (unused) memory block of the device is maintained to locate the root block of a linked list of unused memory blocks. The memory type 224 defines whether the memory is permanently resident in the associated device or whether it is removable. The media types supported 226 contains a list of the various media formats that can be played by the device. The media management attribute 228 states the mode of operation of the device, whether the device is the current media management server master, media management server slave, or a media management client device.

In the media asset table 230, each unique media file is identified using a unique media asset identifier (ID) 232. The title of the media asset 234 and a category stipulation 236 facilitate searching for media files of interest. The media file type 238 helps the content broker 120 determine whether specific devices the user owns have the capability to play the media. The media characteristics 240 define the format of the content, including audio and video fidelity. Usage rights 242 are also included in the media asset table 230. A license key 244 is a database address of the location of a binary large object containing the actual license key issued by the content provider. This key is saved to facilitate validating the original purchase with the third party content provider should it become necessary. The purchase date 246 and a unique distributor purchase ID 248 further define the original purchase transaction and distribution source. In addition, a unique content ID 250 supplied by the distributor facilitates re-obtaining the content if necessary. Finally, a distributor ID 252 identifies the original supplier of the content. This ID can be used to negotiate a subsequent retrieval of the content if it is lost or destroyed.

It should be noted that the preferred embodiment may optionally include storing an original archive copy of the content purchased. Even if the content broker hosting service maintains copies of the content in its disk storage 116, there may be cause to re-negotiate with the third party content providers 140, 142, 144 to obtain new usage policies and associated digital rights license keys, or to obtain a modified version of the content in a different media format so it can be played on a different device.

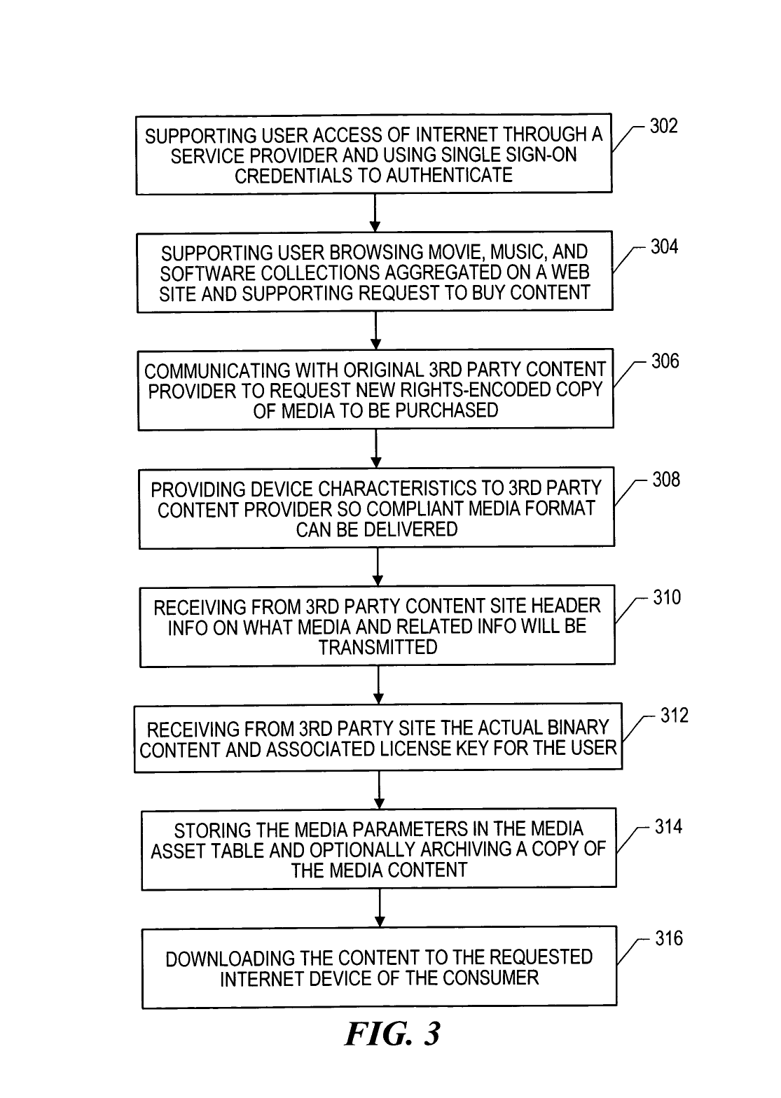

FIG. 3 depicts an exemplary method of a content hosting service 110 aggregating titles of content from various third party suppliers 140, 142, 144 and hosting said titles on its own web server 122. As shown in step 302, the user would first “sign on” to a hosting service by providing single sign-on credentials to the single sign-on identity server 118. The “sign-on” includes a user name and other verification information such as a password or biometric data. The single sign-on information lets the user federate the user's identity with other third party providers 140, 142, 144 and the content hosting service 110. The user can browse the content list stored in the web server 122 and request an item to be purchased, as shown in step 304. As shown in step 306, the content broker process 120 communicates with the third party content provider 140, 142, 144 using standard web services protocols (e.g. Web Services Description Language (WSDL), Simple Object Application Protocol (SOAP), Extensible Markup Language (XML)) to request a purchase of the content. As shown in step 308, the content broker 120 may provide device profile characteristics stored in the device profile table 210 so the content provider can determine a proper media format to deliver to the user. In step 310, the content broker 120 receives the header information (content title, category, media type, usage rights, unique content ID) pertaining to the content that will be provided, and in step 312, the content broker 120 receives the binary content along with the associated license key that defines the usage rights obtained from the user directly from the third party provider 140, 142, 144. As shown in step 314, the media parameters are stored in the media asset table 230, and the content itself is optionally archived in the hosting service's content disk storage 116. As shown in step 316, the content requested is then downloaded to the Internet accessible device of the consumer by the content broker hosting service 110.

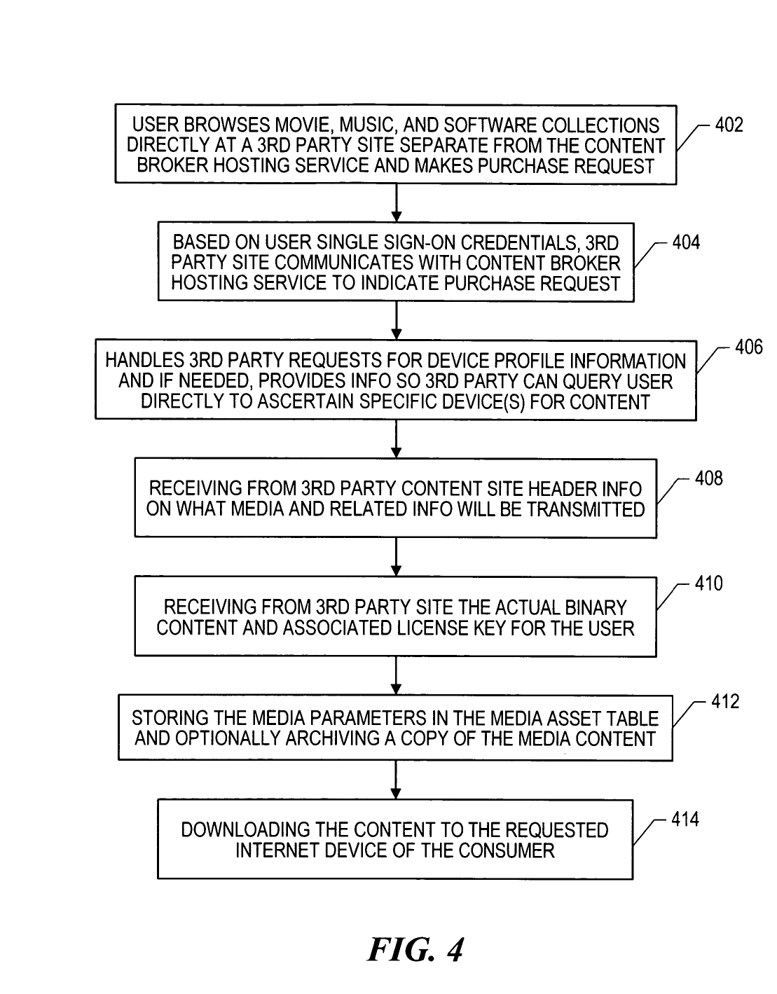

FIG. 4 depicts another exemplary method of a content hosting service 10 supporting requests from various third party content suppliers 140, 142, 144 as a user with a single sign-on account at the content broker hosting service 110 browses other sites directly and decides to purchase content. As shown in step 402, the user would first browse the content available on the third party site 140, 142, 144 and request an item to be purchased. As shown in step 404, the third party site 140, 142, 144 would use the single sign-on credentials to determine if the user had a subscription with the content broker hosting service 110. Once validated, as shown in step 406 the content broker process 120 handles requests for device profile information if needed, and provides enough details on the various devices the user owns so the third party 140, 142, 144 can query the user directly with regard to what device(s) shall be used to consume the content. Using standard web services protocols (e.g. WSDL, SOAP, XML) the third party and the content broker 120 communicate information relating to the content that shall be stored in the media asset table 230, as shown in step 408. As shown in step 410, the content broker 120 receives binary content along with the associated license key that defines the usage rights obtained by the user from the third party provider 140, 142, 144. As shown in step 412, media parameters are stored in the media asset table 230, and the content itself is optionally archived in the hosting service's content disk storage 116. As shown in step 414, the content requested is then downloaded to the device of the consumer by the third party provider 140, 142, 144.

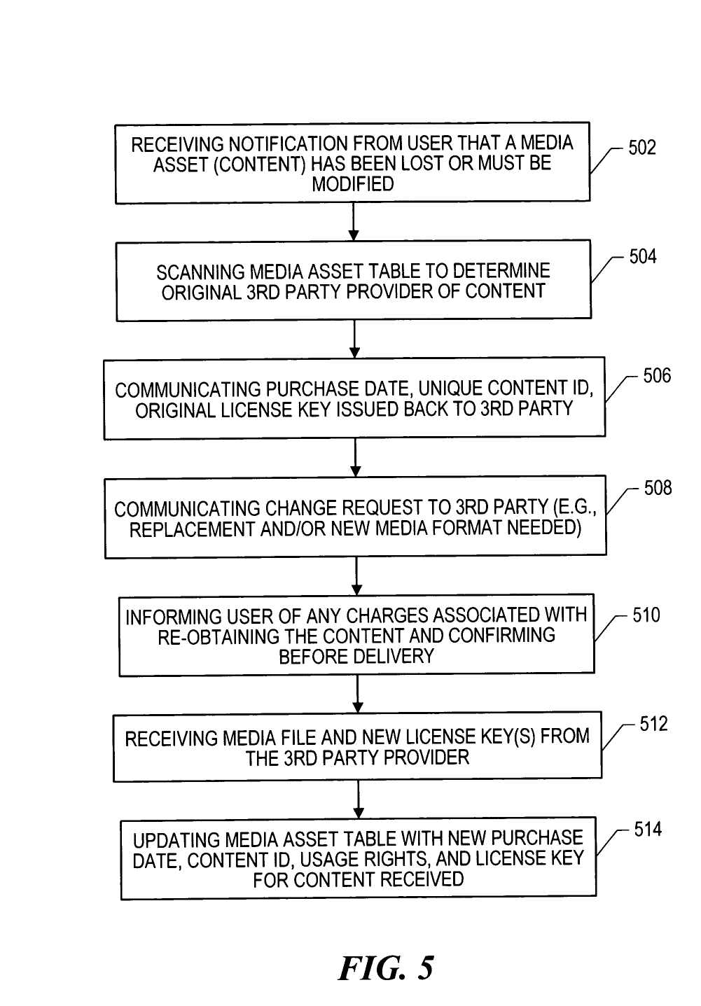

FIG. 5 depicts an exemplary method of the content broker hosting service 110 negotiating on the user's behalf to obtain a new copy of content that was previously purchased by the user. In step 502, the content broker 120 receives a notification from the user that a media asset has been lost, or perhaps the content itself and/or usage rights are to be modified to support playing the content on a different device. As shown in step 504, the content broker 120 scans the media asset table 230 to determine the original third party source of the content, by way of the distributor ID 252. In step 506, the content broker 120 uses web services protocols to communicate with a service provided by the third party provider 140, 142, 144 to provide the purchase date, unique content ID, and original license key issued by the third party provider. As shown in step 508, a reason for the content broker's 120 request may be communicated, such as whether the content was lost or whether the user desires to change rights policies with respect to the media asset. In step 510, the content broker hosting service 110 can optionally inform the user of any potential monetary charges associated with re-obtaining the content or changing the user's rights policies, and receive an acknowledgement from the user prior to proceeding. In step 512, the media file and new license key(s) are received from the third party provider 140, 142, 144 and made available for download by the consumer. The content broker 120 then updates the media asset table 230 with the new usage rights 242, license key 244, purchase date 246, purchased ID 248, and content ID 250, as shown in step 514.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A content broker hosting service module comprising:
a network interface permitting data communication over a network with third party content providers;
a content broker module that communicates with the third party content providers via the network interface to acquire content and associated digital rights license keys;
a device profile table including a device type of a media device and at least one type of media that can be played on the media device; and
a storage device for storing purchased content on behalf of a user;

2. The content broker hosting service module of claim 1, further comprising a media asset table, including, for each of a plurality of media elements, a unique identifier, a title, a category, a media type, a media characteristic, usage rights, a license key, a purchase date, a distributor purchase ID, a distributor unique content ID, and a distributor identifier.

3. The content broker hosting service module of claim 1, further comprising a single sign-on identity service, capable of maintaining user accounts and authentication credentials including password and biometric information to facilitate federation of the sign-on by third party sites.

4. The content broker hosting service module of claim 1, further comprising a web server that aggregates content titles from third parties and offers content identified by the content titles to the user.

5. The content broker hosting service module of claim 1, wherein the network interface uses standard web services protocols to communicate with the third party content providers.

6. The content broker hosting service module of claim 1, wherein the third party content providers use single sign-on credentials to determine the user's subscription to a hosting service and initiate requests to obtain user and device profile information.

7. The content broker hosting service module of claim 6, wherein the content broker module receives media information, media file content, and rights usage license keys in response to a content purchase request by the user.

8. A method of distributing content using a hosting service, the method comprising:
providing a login to the hosting service using a single sign-on account, the hosting service supporting browsing of content titles aggregated from one or more content provider web sites;
responding to a user purchase request for a selected content title;
communicating with at least one of the content provider websites to request to purchase a copy of content associated with the selected content title;
providing user device characteristics so that at least one content provider website may determine a media format for delivery;
receiving media characteristics including media type and fidelity, along with content data and digital rights license keys;
storing the media characteristics in a media asset table at the hosting service; and
optionally downloading the content to a requested user device.

9. The method of claim 8, wherein the content is adaptable with regard to media format, resolution, fidelity, or bit rate to accommodate a second device without reacquiring the content from a content provider website.

10. The method of claim 9, wherein the hosting service obtains a new license key and notifies the content provider website of receipt of the new license key for billing purposes.

11. A method of processing a remote command from a third party site to facilitate direct ordering in conjunction with content broker services, the method comprising:
receiving a request from a third party site inquiring as to the authenticity of a subscriber using a single sign-on identifier to access the third party site;
receiving notification of a purchase request at a content broker site from the third party site;
receiving a request from the third party site regarding device characteristics of a subscriber device;
transmitting device information relating to the device characteristics;
receiving media information including media type, size, license key, and media content; and
storing the media information in a media asset table.

12. The method of processing a remote command of claim 11, wherein the device information includes screen resolution computing capabilities, storage available, and audio capabilities.

13. The method of processing a remote command of claim 11, further comprising storing a copy of the media content.

14. The method of processing a remote command of claim 11, further comprising downloading the media content to a requested device of the subscriber in response to the third party site.

15. A method of processing a request from a content service user, the method comprising:
receiving a request from the user to replace a media file;
scanning a media asset table to determine a supplier of the media file;
communicating a purchase date, content identifier, and original license key to the supplier of the media file;
informing the user of charges associated with re-obtaining the media file;
receiving the media file and a new license key from the supplier of the media file; and
updating the media asset table with an updated purchase date, content identifier, usage rights, and the new license key.

16. A system to provide a content brokerage service, the system comprising:
an interface to a distributed computer network, the distributed computer network providing access to a remote content provider;
a content broker module coupled to the interface;
a single sign-on identity service to authenticate a subscriber to a content brokerage service supported by the content broker module; and
a memory including content asset information and device profile information associated with at least one subscriber to the content brokerage service.

17. The system of claim 16, wherein the content broker module facilitates a distribution of an updated license key and content to the at least one subscriber.

18. The system of claim 17, wherein the content broker module requests the remote content provider to distribute the updated license key and the content.

19. The system of claim 18, wherein the content broker module receives a request from the at least one subscriber for the updated license key.

20. The system of claim 19, wherein the at least one subscriber provides notification to the content brokerage service that an original content file is no longer available for use before the content broker module receives the request for the updated license key.

21. The system of claim 16, wherein the device profile information includes a first device identification of a first device, a first device type of the first device, and a first supported media type for the first device.

22. The system of claim 21, wherein the device profile information further includes a device characteristic of the first device and a memory address to identify a free memory block suitable to store distributed content data.

23. The system of claim 16, wherein the content asset information is a media asset table including a media asset identity, a media asset title, a media asset category, a media type, usage rights, and a license key.

24. The system of claim 23, wherein the media asset table further includes purchase data and a content distributor identity.

25. The system of claim 16, wherein the content asset information is a media asset table that includes a plurality of content asset entries, each of the plurality of content asset entries including a content title and a license key.

26. The system of claim 16, wherein the remote content provider communicates with the content broker module to indicate a content purchase request made on behalf of the at least one subscriber.

27. The system of claim 26, wherein the content broker module accesses the memory to retrieve the device profile information.

28. The system of claim 27, wherein the content broker module communicates the device profile information to the remote content provider.

29. A method of managing content, the method comprising:
receiving a request for modified content with respect to a first version of content distributed to a user;
determining a content provider associated with the first version of content;
communicating data to the content provider, the data associated with the distribution of the first version of content;
communicating a modified content request to the content provider; and
receiving a second version of the content and a second license key associated with use of the second version of the content.

30. The method of claim 29, further comprising retrieving the data from a media asset table to determine the content provider associated with the first version of the content.

31. The method of claim 30, further comprising storing data associated with the second version of the content into the media asset table.

32 The method of claim 29, wherein the data associated with the distribution of the first version of the content includes a unique content identification and a first license key.

33. The method of claim 32, wherein data associated with the distribution of the first version of the content further includes purchase data.

34. The method of claim 33, wherein data associated with the second version of the content includes a second purchase date, a second content identifier, and a second license key.

35. The method of claim 29, wherein the second version of the content has a different media format than the first version of the content.

36. The method of claim 29, further comprising receiving an indication of a fee to be charged by the content provider to provide the second version of the content.

37. The method of claim 36, further comprising receiving confirmation from the user to pay the fee to the content provider.

38. The method of claim 29, wherein the second version of the content and the second license key are distributed to the user.

39. The method of claim 29, wherein the request for modified content is received at a first computer site and wherein the second version of the content is stored at a second computer site associated with the content provider.

40. The method of claim 39, wherein the second version of the content is communicated from the second computer site to the first computer site.

41. The method of claim 40, wherein the second version of the content is a rights encoded copy of a media file.

42. A method of managing media content, the method comprising:
authenticating a subscriber to a content brokering site of a computer network;
providing device characteristics of a subscriber media device, the device characteristics communicated from the content brokering site to a remote content provider site;
receiving content site header data relating to media type from the remote content provider site; and
receiving media content and an associated license key allowing access to the media content from the remote content provider site.

43. The method of claim 42, further comprising storing the media type in a computer memory.

44. The method of claim 43, further comprising storing the media content in the computer memory.

45. The method of claim 42, further comprising distributing the media content to the subscriber media device.

46. The method of claim 42, wherein single sign-on credentials are used to perform the step of authenticating the subscriber.

47. The method of claim 42, wherein the subscriber device is one of a computer, a set top box, a DVD player and an MP3 player.

48. The method of claim 42, wherein the media file is selected from at least one of a movie file, a music file, and a software program.

49. The method of claim 42, further comprising authenticating a plurality of subscribers and receiving content requests from each of the plurality of subscribers.
